(19) United States
(12) Patent Application Publication
(10) Pub. No.: US 2004/0174488 A1
(43) Pub. Date: Sep. 9, 2004

(54) SYMMETRICAL LIQUID CRYSTAL DISPLAY PANEL

(76) Inventor: Shang-Kung Tsai, Kao-Hsiung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,717

(22) Filed: Oct. 21, 2003

(30) Foreign Application Priority Data
Jun. 3, 2003 (TW) 092114983
Mar. 7, 2003 (TW) 092105011

(51) Int. Cl. G02F 1/1345

(52) U.S. Cl. 349/152

(57) ABSTRACT

A symmetrical LCD panel has a substrate, at least a source driver IC positioned on a central part of a peripheral area of the substrate, a flexible circuit board positioned on the same side as the source driver IC of the substrate, at least a gate driver IC positioned on a central part of the flexible circuit board, and a plurality of conductive wires connected to the gate driver IC, the source driver IC, and a display area of the substrate.

### BACKGROUND OF INVENTION

1. Field of the Invention

The present invention relates to a liquid crystal display (LCD) panel, and more particularly, to a symmetrical LCD panel.

2. Description of the Prior Art

LCDs have been widely applied to a variety of information products, such as notebook computers and PDAs, because of their small size, low power consumption, and low radiation emission.

Refer to FIG. 1, which is a schematic diagram of a conventional LCD panel 10. As shown in FIG. 1, the conventional LCD panel 10 comprises a glass substrate 12 having a display area 14 and a peripheral circuit area 16 on the surface, at least a source driver IC 18 and at least a gate driver IC 20 positioned on the peripheral circuit area 16, and a flexible printed circuit board 22 positioned at an edge of the peripheral circuit area 16.

The flexible printed circuit board 22 comprises a circuit, which has a plurality of conductive wires 24, electrically connected to the source driver IC 18, the gate driver IC 20, and electrodes (not shown) on the glass substrate 12. In addition, the flexible printed circuit board 22 serves as a connector for connecting the LCD panel 10 with other electronic elements (not shown), and for transmitting signals to the source driver IC 18 and the gate driver IC 20. The source driver IC 18 and the gate driver IC 20 control image display of the LCD panel 10 by inputting signals to the electrodes (not shown) on the glass substrate 12.

At present, the driver IC cannot be formed in the LCD panel by mass production due to technological constraints. Therefore, the driver IC is connected to the LCD panel using a tape carrier package (TCP) or by chip on glass (COG) technology. Since a TCP has large size and only allows packaging one driver IC, TCP is normally applied to larger panels. COG technology is a flip chip method that binds ICs on the circuit of the substrate by using anisotropic conductive film (ACF) or silver glue.

However, if one driver IC is not well treated, the whole panel must be discarded. Thus, the COG technology is normally applied to smaller panels that use fewer ICs.

In addition, the source driver IC 18 and the gate driver IC 20 are positioned on different sides of the peripheral circuit area 16 for respectively controlling data lines (not shown) and scan lines (not shown) of the LCD panel 10. Nevertheless, the display area 14 is not on the central part of the glass substrate 12, which increases the overall volume of the LCD panel 10. Besides, the flexible printed circuit board 22 is positioned at the corner of the glass substrate 12 for connecting to both the source driver IC 18 and the gate driver IC 20. This arrangement makes the LCD panel 10 unsymmetrical. Furthermore, due to the arrangement of the source driver IC 18 and the gate driver IC 20, the conventional LCD panel 10 cannot be applied to small information products that require a symmetrical display.

### SUMMARY OF INVENTION

It is therefore a primary object of the present invention to provide a symmetrical LCD panel applied to information products that require a small and symmetrical display.

Accordingly, the preferred embodiment of the present invention discloses a symmetrical LCD panel. The LCD panel comprises a substrate having a display area positioned on the central part of the substrate and a peripheral circuit area positioned on the surface of the substrate, at least a source driver IC positioned on the central part of the peripheral circuit area, and a flexible circuit board positioned at the outside perimeter of the peripheral circuit area. The flexible circuit board is positioned on the same side as the source driver IC, and includes an extension portion having at least a gate driver IC positioned at the center. The LCD panel further comprises a plurality of conductive wires connected to the gate driver IC, the source driver IC, and the display area.

The gate driver IC of the present invention is installed on the flexible circuit board rather than being installed at the edge of the glass substrate. Consequently, more area remains for the bonding pad of the source driver IC. This reduces the possibility of substandard assembly for the source driver IC. In addition, the display area is positioned on the central part of the substrate, the source driver IC is installed on the central part of the peripheral circuit area, and the gate driver IC is installed at the center of the flexible circuit board such that the LCD panel becomes a symmetrical LCD panel.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a conventional LCD panel.

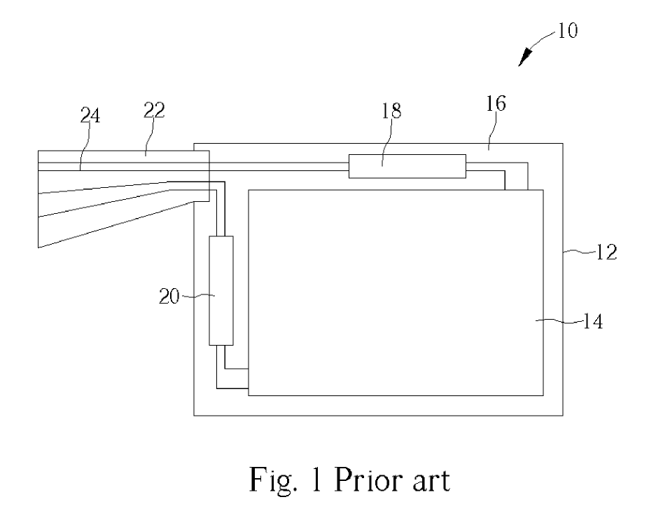

FIG. 2 is a schematic diagram of an LCD panel of the present invention.

FIG. 3 is a schematic diagram illustrating the LCD panel shown in FIG. 2 applied to a cellular phone.

### DETAILED DESCRIPTION

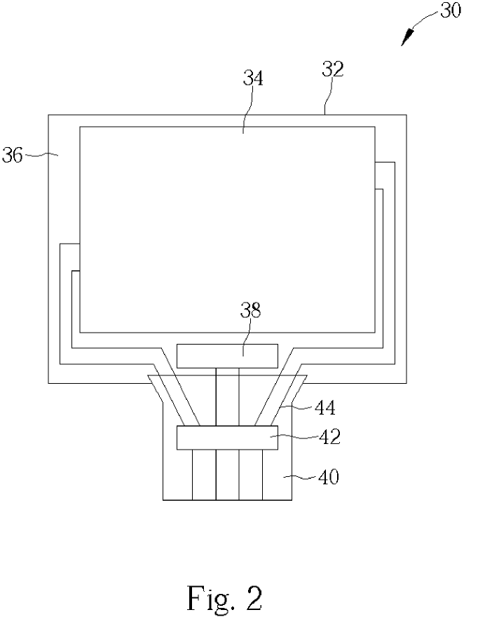

Refer to FIG. 2, which is a schematic diagram of a LCD panel 30 of the present invention. As shown in FIG. 2, the LCD panel 30 of the present invention comprises a glass substrate 32 having a display area 34 and a peripheral circuit area 36 on the surface, a source driver IC 38 positioned on the central part of the peripheral circuit area 36, and a flexible circuit board 40 positioned at the perimeter of the glass substrate 32. The flexible circuit board 40 and the source driver IC 38 are positioned on the same side of the glass substrate 32. The flexible circuit board 40 further comprises an extension portion having at least a gate driver IC 42 positioned at the center, and a plurality of conductive wires 44 connected to the gate driver IC 42, the source driver IC 38, and electrodes (not shown) of the display area 34. In addition, the flexible circuit board 40 can be a flexible printed circuit (FPC) board, a flexible copper clad laminate (FCCL), or a tape carrier package (TCP).

The source driver IC 38 can be installed on the glass substrate 32 by COG technology. The gate driver IC 42 can be installed on the flexible circuit board 40 by chip on film (COF) technology. COF technology utilizes a sealant having conductive particles, such as anisotropic conductive film (ACF) to fix the gate driver IC 42 on the central part of the flexible circuit board 40 such that protrusions (not shown) are connected to the conductive wires 44 of the flexible circuit board 40.

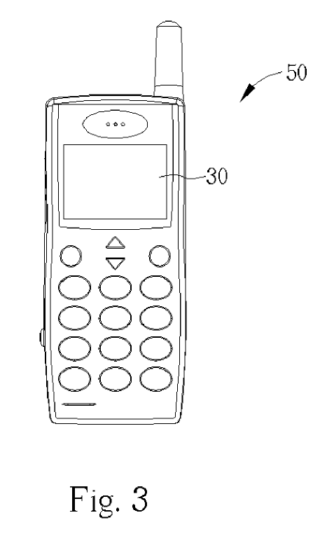

Refer to FIG. 3 which is a schematic diagram illustrating the LCD panel 30 shown in FIG. 2 applied to a cellular phone 50. As shown in FIG. 3, since the gate driver IC 42 is positioned on the central part of the flexible circuit board 40, the glass substrate 32 only includes the source driver IC 38. Consequently, the display area 34 is located in the central part of the glass substrate 32. This arrangement makes the cellular phone 50 smaller and provides it with a symmetrical display.

Furthermore, since the LCD panel 30 only comprises the source driver IC 38, the area for a bonding pad becomes larger. This avoids the assembly difficulty of the source driver IC, and further increases the viewable range of the display area 34.

It is worth noting that while the preferred embodiment of the present invention addresses a small-size LCD panel as an example, the present invention can still be applied to various LCD panels, such as amorphous silicon thin film transistor LCD panels. In addition, the LCD panel of the present invention is not limited to being applied to cellular phones. The present invention can be applied to any information products that require a symmetrical display, such as smart phone. Besides, in the present invention the source driver IC can be installed on the flexible circuit board while the gate driver IC can be installed on the substrate thereby achieving the same effect. Additionally, the shape of the glass substrate and the flexible circuit board is not limited to rectangular. The glass substrate and flexible circuit board having a symmetrical shape, such as an octagon or trapezoid, can also be employed in the present invention.

In comparison with the prior art, the LCD panel of the present invention comprises at least a source driver IC formed on the glass substrate by COG technology and at least a gate driver IC installed on the flexible circuit board by COF technology. Hence, the peripheral circuit area is reduced and the display area is increased. Furthermore, this arrangement makes the LCD panel meet the symmetry requirement of many information products.

Those skilled in the art will readily appreciate that numerous modifications and alterations of the device may be made without departing from the scope of the present invention. Accordingly, the above disclosure should be construed as limited only by the metes and bounds of the appended claims.

What is claimed is:

1. A symmetrical liquid crystal display panel comprising:
a substrate having a display area positioned on a central part of the substrate, and a peripheral circuit area positioned on a surface of the substrate;
at least a source driver IC positioned on a central part of the peripheral circuit area;
a flexible circuit board positioned at the outside perimeter of the peripheral circuit area on the same side as the source driver IC, the flexible circuit board having at least an extension portion comprising at least a gate driver IC positioned on a central part of the extension portion; and
a plurality of conductive wires connected to the gate driver IC, the source driver IC, and the display area of the substrate.

2. The symmetrical liquid crystal display panel of claim 1 wherein the liquid crystal display panel is an amorphous silicon thin film transistor liquid crystal display panel.

3. The symmetrical liquid crystal display panel of claim 1 wherein the substrate is a rectangular glass substrate.

4. The symmetrical liquid crystal display panel of claim 1 wherein the symmetrical liquid crystal display panel is applied to a cellular phone or a smart phone.

5. The symmetrical liquid crystal display panel of claim 1 wherein the flexible circuit board comprises a flexible printed circuit (FPC) board, a flexible copper clad laminate (FCCL), or a tape carrier package (TCP).

6. A liquid crystal display panel comprising:
a substrate having a display area and a peripheral circuit area positioned on a surface of the substrate;
at least a first driver IC positioned on the peripheral area of the substrate;
a flexible circuit board positioned at the outside perimeter of the peripheral circuit area on the same side as the first driver IC, the flexible circuit board having an extension portion comprising at least a second driver IC; and
a plurality of conductive wires connected to the first driver IC, the second driver IC, and the display area of the substrate.

7. The liquid crystal display panel of claim 6 wherein the liquid crystal display panel is an amorphous silicon thin film transistor liquid crystal display panel.

8. The liquid crystal display panel of claim 6 wherein the first driver IC is a source driver IC and the second driver IC is a gate driver IC.

9. The liquid crystal display panel of claim 6 wherein the substrate is a rectangular glass substrate.

10. The liquid crystal display panel of claim 9 wherein the source driver IC is positioned on the central part of the peripheral circuit area that is on a longer side of the substrate, the gate driver IC is positioned on the central part of the flexible circuit board, and the display area is positioned on the central part of the substrate such that the liquid crystal display panel is a symmetrical liquid crystal display panel.

11. The liquid crystal display panel of claim 10 wherein the symmetrical liquid crystal display panel is applied to a cellular phone or a smart phone.

12. The liquid crystal display panel of claim 6 wherein the flexible circuit board comprises a flexible printed circuit (FPC) board, a flexible copper clad laminate (FCCL), or a tape carrier package (TCP).
